(19) United States
(12) Patent Application Publication
(10) Pub. No.: US 2004/0243811 A1
(43) Pub. Date: Dec. 2, 2004

(54) Electronic signature method with a delegation mechanism, and equipment and programs for implementing the method

(75) Inventors: Laurent Frisch, Paris (FR); Dimitri Mouton, Paris (FR)

Correspondence Address: GARDNER CARTON & DOUGLAS LLP, ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 10/828,729

(22) Filed: Apr. 21, 2004

(30) Foreign Application Priority Data
Apr. 22, 2003 (FR) 03 04920

(51) Int. Cl. H04L 9/00

(52) U.S. Cl. 713/176

(57) ABSTRACT

A token of delegation from a first signatory to a second signatory is generated and the delegation token is associated with a document signed electronically by means of a cryptographic key of the second signatory. The delegation token contains delegation data signed electronically for the first signatory, in particular an identifier of the second signatory. It is generated by a server in response to a request relating to the signing of the document, sent by the second signatory.

The present invention relates to electronic signature techniques and aims to propose an efficient and reliable process for delegating electronic signatures.

### BACKGROUND OF THE INVENTION

The certificate is the basic object inspiring confidence in the public part of a cryptographic key (public key). The certification standard which is in use in many networks, including the Internet, is version 3 of the X.509 standard. A specification of this standard is available from the PKIX working group of the Internet Engineering Task Force (IETF) in Request For Comments (RFC) 3280, “Internet X.509 Public Key Infrastructure; Certificate and Certificate Revocation List (CRL) Profile”, published in April 2002. The certificate is an object comprising in particular:

the public key to be certified,

the identity of its owner,

a validity period, and

a cryptographic signature of the data using the private key of a certification authority (CA) issuing the certificate.

An electronic signature function guarantees the authenticity of a document, i.e. it reliably authenticates its signatory or signatories, and its integrity, i.e. it guarantees that the document has not been modified. An electronic signature is often used to guarantee non-repudiation of a document, i.e. subsequent denial of the document by its author.

The formats most commonly used for signed messages are:

PKCS#7, published by RSA Security, Inc. and by the IETF in March 1998 (RFC 2315, “PKCS#7: Cryptographic Message Syntax; Version 1.5”), which was adopted in IETF RFC 2630, “Cryptographic Message Syntax (CMS)”, June 1999. These standards are used in particular in the Secure Multipurpose Internet Mail Extensions (S/MIME) specification for signed electronic mail. They are based on PKIX certificates (X.509, CRL, OCSP).

XML-DSig, part of the family of extended Markup Language (XML) data formats. Not widespread at present, this format will develop in parallel with the expansion of XML technologies.

PGP, corresponding to signed messages issued by the Pretty Good Privacy (PGP) software from Networks Associates Technology, Inc. and analogous products. Its certificates are different from PKIX certificates.

Other so-called “multi-actor” or “multi-agent” techniques, for example group signature, propose an electronic signature guaranteeing some degree of anonymity to the signatory by enabling him to sign on behalf of a group of persons.

The prior art electronic signature formats do not support a mechanism for delegating certified cryptographic keys to enable secure signature by a delegate.

In systems that support delegation, this generally means the delegation of powers, with approvals managed by the system internally or via a more general directory.

For example, in a workflow management system, it is possible to define a group of “titleholders” having the right to take decisions within the system. To alleviate possible absence of the titleholders, each of them may have one or more delegates. On the decision of a titleholder (i.e. an action in the workflow, for example to take paid leave), some or all of the titleholder's authorizations are assigned to the delegate, so as not to interrupt the workflow. Decisions in the workflow taken by the delegate are taken in the delegate's own name. All trace of delegation is usually lost once the delegation period has expired. In the best cases, it may be discovered by examining logs recording the history of the workflow. However, that kind of search operation is complex and costly, especially if it needs to be carried out a long time after the event.

In the case of workflows using electronic signature functions, i.e. in which the object of the decision is to sign a document, existing electronic signature formats provide no “per pro” field indicating the titleholder in whose name the delegate has signed. Thus the signed document, once it has left the workflow context, for example to be processed by a third party or placed in archival storage, comprises only the signature of the delegate, with no trace of the titleholder who delegated the power to sign.

More generally, in current systems, delegation of the power to sign is not recorded in the electronic signature and therefore cannot be discovered once the signed document has left the delegation context.

This kind of delegation by management of authorizations offers no guarantee to third parties having to carry out verification a posteriori. It does not enable reliable data to be included in a standard data format (for example the PKCS#7 format). Prior art delegation techniques keep only a short term trace of delegation, which makes them inadequate for applications processing longer term data, such as electronic signatures.

The electronic signature must be permanent, and with it information for determining under what conditions it was executed, such as the “per pro” indication as used in the case of a handwritten signature, for example.

One object of the present invention is to alleviate these limitations of the prior art.

### SUMMARY OF THE INVENTION

The invention thus proposes a method of electronically signing documents, comprising the steps of generating a token of delegation from a first signatory to a second signatory, and associating the delegation token with a document signed electronically by means of a cryptographic key of the second signatory. The delegation token contains delegation data electronically signed for the first signatory, the delegation data including an identifier of the second signatory. The token is generated by a server in response to a request sent by the second signatory in connection with the signing of the document.

The above method remedies the drawbacks explained hereinabove by providing effective and practical means for delegating cryptographic powers by including a token containing information on delegation, supplied in each individual circumstance by a delegation management server. The token included in the signature assures full compliance with the most widespread electronic signature standards.

Another aspect of the present invention provides a computer program adapted to be installed in a computer device for electronic signature of documents by a second signatory delegated by a first signatory, comprising instructions for carrying out a method as set out hereinabove when the program is run by processing means of said device.

Another aspect of the present invention provides a computer device for electronic signature of documents by a second signatory delegated by a first signatory, comprising means for electronically signing a document by means of a cryptographic key of the second signatory, means for obtaining a token of delegation from the first signatory to the second signatory, and means for associating the delegation token with the signed document, wherein the delegation token comprises delegation data electronically signed for the first signatory, and wherein the delegation data include an identifier of the second signatory. The means for obtaining the delegation token are adapted to send a request relating to the signing of the document (M) to a server and to receive the token in response to said request.

Another aspect of the present invention provides a delegation server for use in the electronic signing of documents by a second signatory delegated by a first signatory, comprising means for carrying out a method as defined hereinabove. This kind of server supplies the delegation token to the second signatory and/or associates the token with the document signed electronically by the second signatory.

In an advantageous embodiment, the request sent by the second signatory in relation to signing the document is accompanied by data depending on the document to be signed, which are included in the delegation data to generate a delegation token that is valid for only one document, and therefore not replayable.

The invention further proposes computer programs adapted to be installed in a computer device or in a delegation server for the electronic signing of documents by a second signatory delegated by a first signatory. The programs comprise instructions for carrying out a method as defined hereinabove when they are run by processing means of said device or server.

### BRIEF DESCRIPTION OF THE DRAWINGS

FIG. 1 is a diagram depicting the structure of a cryptographic envelope that may be used in accordance with the invention.

FIGS. 2 and 3 are flowcharts illustrating two implementations of the method of the invention.

### DESCRIPTION OF PREFERRED EMBODIMENTS

A cryptographic token consists of data that is usually signed by a person, an authority, or a server and contains administrative information relating to another document; it is usually transmitted at the same time as the document.

For example, a timestamp token defined in the Time Stamp Protocol (TSP, see RFC 3161, “Internet X.509 Public Key Infrastructure Time-Stamp Protocol (TSP)”, August 2001, IETF), contains the date and the time of a document, and it is signed by a timestamping third party.

The present invention introduces the concept of delegation token providing a way of enabling a document signed electronically by a delegate on behalf of a titleholder to include a permanent trace of the delegation, which trace can be verified and cannot be repudiated.

A delegation token J may be integrated into an electronic signature in three ways:

as an integral part of the data to be signed, the integrity of which is guaranteed by the signature,

as an authenticated attribute, the integrity of which is guaranteed by the signature, or

as a non-authenticated attribute included in the signature envelope but whose integrity is not guaranteed by the signature.

Each way has advantages depending on the context in which the method is executed.

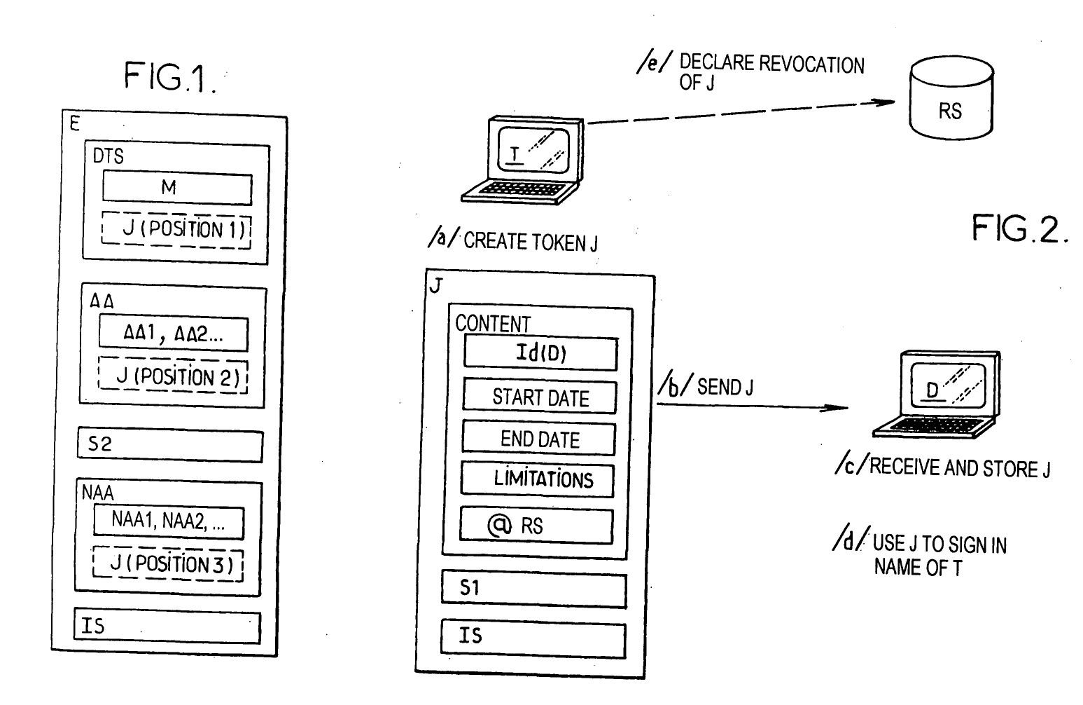

Let M denote the message or document to be signed by the delegate D on behalf of the titleholder T using the delegation token J. The result of this signature is usually called the signature envelope E. Referring to FIG. 1, the signature envelope E comprises the following data, for example:

the data to be signed (DTS), which contains at least the message M, but may further contain other information as a function of its format, for example cryptographic tokens,

authenticated attributes (AA), which may comprise one or more fields that contain diverse information and in particular cryptographic tokens,

the signature S2 proper, which is calculated with a private cryptographic key of the signatory D and applies both to DTS and to AA,

information on the signatory (IS), in particular the certificate of the signatory D, and optionally a string of certificates for verifying its validity, and

non-authenticated attributes (NAA), which may comprise one or more fields that contain diverse information and in particular cryptographic tokens.

The above kind of cryptographic envelope structure is encountered in particular in the context of a signature to the standard PKCS#7 format. It should be mentioned here that the DTS may be detached, i.e. not contained in the envelope, and that the AA and the NAA are optional.

FIG. 1 shows in chain-dotted line three possible positions of the delegation token J in the signature envelope E:

In position 1 (DTS), the token J is part of the signed data, and therefore of the message, in the broad sense of the term. Thus the signed data comprises not M alone, but {M, J}. This is comparable to a handwritten “per pro” indication added to a document before signing it: the delegation token is truly part of the signed data. This requires that the format of the signed data allow this modification. For example, if the addressee is expecting to find in the signed data only a page description format (PDF) file, the addition of J to the data may be considered as pollution of the format. On the other hand, if the DTS consists in concatenated fields of a form, J may be considered a supplementary field.

In position 2 (AA), the token J signed on the same basis as in position 1, but as ancillary information, so to speak. If the envelope contains authenticated attributes, it is the authenticated attributes that are signed, and the authenticated attributes necessarily contain a hash of the DTS, i.e. a code calculated by applying a standard hashing algorithm to the DTS. Position 2 offers good properties because it does not change the nature of the signed message M when it adds the token J to the elements authenticated by the electronic signature S2 of D.

In position 3 (NAA), the token J is simply attached to the signed data and to the signature S2, but is not signed itself. Because of this, it may be removed or added without this changing the validity of the signature itself. This is the general case for cryptographic tokens, for example timestamp tokens. This is comparable to an independent sheet appended to a document signed elsewhere to prove the delegation of the power of signature for that document.

Several methods of creating the delegation token are proposed, with different practical benefits, adapted to different organizational constraints:

direct delegation, without intervention by a server, or

delegation with intervention by a server.

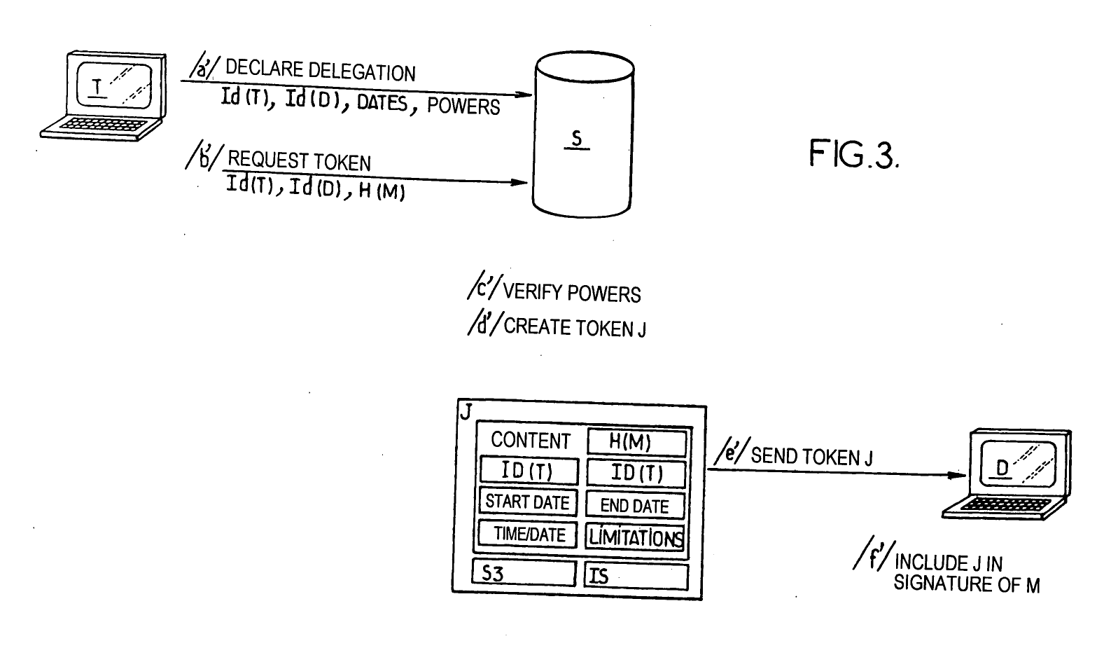

These methods are described hereinafter with reference to FIGS. 2 and 3, which show the data processing devices used by the titleholder T and the delegate D, for example computers or terminals communicating with each other via one or more telecommunications networks (not shown), for example an IP network such as the Internet or an Intranet. These devices are equipped with programs for executing the steps described hereinafter. FIGS. 2 and 3 also show a delegation server S and a revocation server RS that may be used in some embodiments of the method. These servers are connected to the telecommunications network and are also equipped with programs adapted to execute the steps described hereinafter, for example in the context of a signature delegation web service. In the first method (FIG. 2), the titleholder T sends the delegation token J directly to his delegate D, who then includes it in electronic signatures on behalf of T, at one of the three positions represented in FIG. 1. Delegation may then proceed as follows.

/a/ T creates the token J by signing with his private key delegate data comprising:

an identifier of D, which may be the public key of D associated with his private key in an asymmetric cryptographic system, for example, or is preferably the electronic certificate of D (which includes his public key),

data describing the validity period of the delegation and thus of the token J; this data typically indicates a start of period date and an end of period date or a duration,

a delegation validity functional limit, which may take the form of a text describing the powers conferred upon D that are attested to by the token J, a list of accessible functions, or a maximum authorized amount if the delegated powers relate to purchasing, etc.,

where applicable, the address @RS of the revocation server to which T is subsequently liable to declare revocation of the delegation token.

T integrates into the token J the electronic signature S1 of the delegation data. T may add to the token J a timestamp of the token or any other useful information.

/b/ T sends the token J to D, for example by e-mail or by any other electronic means, thereby informing D of his delegated powers.

/c/ D receives and retains the token J.

/d/ Each time that D signs on behalf of T, J is included in the envelope E of the signature, at one of the three positions shown in FIG. 1.

A single delegation token is thus obtained for all the delegation period, usable by D at his discretion, and depending not on data signed by D but only on the delegation period.

In this case, it is preferable to couple the use of the delegation token to timestamping of signatures applied by D on behalf of T in order to be able to ensure a posteriori that the signatures were applied during the specified period of validity.

In a different embodiment, the token J is deposited by T with the delegation server S (not shown in FIG. 2). D may then ask S for the delegation token each time that he requires to include it in a signature. There may also be provision for the token J deposited with the server S after its creation by T to be included by S, to whom D sends the delegated signatures that he applies. In this case, J could be included only at the position 3 indicated in FIG. 1.

In an advantageous embodiment, the titleholder T is able to revoke his delegation of D. A server RS, analogous to the CRL servers of the X.509 standard, is then used that keeps up to date lists of revoked delegation tokens and to which the titleholder T declares revocation of the token, where applicable (/e/ in FIG. 2). A token validity on-line control protocol might also be envisaged, analogous to the on-line certificate status protocol (OCSP) for certificates (see RFC 2560, “Internet X.509 Public Key Infrastructure; Online Certificate Status Protocol—OCSP”, published in June 1999 by the IETF). The token J then contains an address @RS corresponding to the server RS forming the distribution point of the revocation list or of the on-line control service.

The second method (FIG. 3) of obtaining a delegation token J uses a delegation server. The titleholder T declares the delegation to a server S, which assumes responsibility for creating the token J on each request from the delegate D. The token is either sent to the delegate D in order to be associated with signatures applied by D or included directly by the server S in signatures applied by D and sent to S for this purpose. This method has the advantage of enabling a different token J to be generated for each signature, and for J to include not only the delegation information but also a timestamp for the delegation request or data depending on the signed message, for example a hash thereof. The token is included in the electronic signatures in exactly the same way as in the above situation, at one of the three positions depicted in FIG. 1.

Delegation may then proceed in the following manner.

/a′/ T declares the delegation to S by supplying S with its own identity (for example its certificate), the identity of the delegate, and the temporal and functional limits of the delegation, and advises D of this by any means (e-mail, telephone, alert sent by S, etc.).

/b′/ If D requires to sign a message M electronically on behalf of T, D sends a delegation token request to S.

/c′/ S verifies that delegation from T to D is actually in force.

/d′/ S creates the token J, signing with a private key associated with the delegation data service, comprising the same data as that indicated in step /a/ above, plus an identifier of T, for example the public key of T or the electronic certificate of T. S integrates the electronic signature S3 of the delegation data into the token J. Where applicable, S may add to the token J a timestamp of the token or any other useful information.

/e′/ S sends the token J to D, for example by e-mail or by any other electronic means.

/f′/ D includes J in the envelope E of the electronic signature that it is applying on behalf of T, at one of the three positions shown in FIG. 1.

There is obtained in this way a delegation token that may be different for each signature applied by D on behalf of T during the delegation period.

If the token J does not depend on M and includes no precise intrinsic timestamp, it is beneficial to couple the use of the delegation token to timestamping of signatures applied by D on behalf of T to be able to assure a posteriori that these signatures were made during the period of validity of the token, and therefore during the delegation period.

In a preferred embodiment, the token J depends on the message M. For the token J not to be usable again by D in some other electronic signature window, it is advantageously made dependent on the signed message M. To this end, D appends to its token request a hash H (M) of the message.

In order to locate the electronic signature in time and to be able to verify a posteriori that the powers were used correctly and in the correct period, the server S may add a timestamp to J; it may either insert the time of creation of the token itself or include therein a timestamp token obtained from a third party timestamping server, for example using the TSP.

The declaration of delegation by the titleholder T (step /a′/) may employ a declaration web service hosted by the server S, in accordance with the following procedure:

T connects to S and accesses an HTML page containing a delegation declaration form and a mobile code application (“applet”) for signing the form using an electronic signature device already present at the station of T,

T fills in the form with the delegation limit dates, the associated limitations on powers, and the identity of the delegate, selectable by interrogating an electronic directory; and

T signs the form and sends it to S, who verifies the signature before storing the data in the form in his database.

When the delegation becomes effective, S informs D of this by means of an e-mail, using the address contained in the certificate of D or found in the directory.

D may also sign on behalf of T in the context of a web service hosted by the server S, via another HTML page containing a form to be filled in and an applet for signing the form using an electronic signature device already present at the station of D, as well as obtaining a delegation token from the server S. If a form must be signed by a delegate, a particular button on the form invokes the applet for fetching the delegation token.

When D clicks on this button, a delegation token request is sent to S (/b′/). The request contains the identity Id (T) of the titleholder T (selectable from the directory), the identity Id (D) of the delegate D, and the hash H (M) of the message M to be signed (as a general rule, M consists of concatenated fields of the form in accordance with a predefined format for the service concerned). If necessary, the request may also contain elements enabling S to verify that the message M conforms to the limitations imposed by T on the extent of the delegation, for example the amount of a financial commitment.

On receiving the request, S consults its database to verify that delegation from T to D is in fact active (/c′/) and verifies the limitations thereof, if necessary. S then creates the delegation token J with the format described hereinabove (/d′/) and sends it to D in response to the latter's request (/e′/). The signature is applied by the applet downloaded to the station of D and the token J is included therein (/f′/). The signature is then processed by the service in accordance with the standard processing logic defined for the service.

On the other hand, instead of sending S a delegation token request, D may send S directly the signature that it has applied on behalf of T, in order for S itself to include therein the token J created in the above step /d′/. In this case, J could be included only at the position 3 indicated in FIG. 1.

If the addressee of the electronic signature applied by D on behalf of T wishes to verify its validity, he proceeds as for a normal signature, and adds the following verification steps:

extract the token J,

verify the cryptographic validity of the token J using the field IS containing the certificate of the signatory of the token (T or S), verifying also that the signatory is approved to sign delegations (trusted authority or necessary attribute in the certificate); where applicable, it may be necessary to work back through the whole of a chain of certification,

verify if the token J contains a revocation control address assuring non-revocation,

verify the validity of the timestamp, if applied by a method which requires verification (TSP, for example),

verify that the timestamp indicates a date between the dates on which the validity of the token J begins and ends,

if the token J contains a hash of the signed message, verify that hash by comparing it to a new calculation applied to the message M actually sent,

if necessary, verify that the limitations indicated in the token J are compatible with the signed information, and

verify that the identity of the delegate mentioned in the token conforms to the identity of the signatory.

If all these verifications yield a correct result, then the signature may be considered as having been applied by D on behalf of T.

What is claimed is:

1. A method of electronically signing documents, comprising the steps of generating a token of delegation from a first signatory to a second signatory, and associating the delegation token with a document signed electronically by means of a cryptographic key of the second signatory, wherein the delegation token contains delegation data electronically signed for the first signatory, wherein the delegation data include an identifier of the second signatory, and wherein the delegation token is generated by a server in response to a request sent by the second signatory in connection with the signing of the document.

2. A method according to claim 1, wherein the electronic signature performed by means of the cryptographic key of the second signatory is applied to the document accompanied by the delegation token.

3. A method according to claim 1, wherein the electronic signature performed by means of the cryptographic key of the second signatory is applied on the one hand to the document and on the other hand to authenticated attributes including the delegation token.

4. A method according to claim 1, wherein the delegation token is associated with the document signed by means of the cryptographic key of the second signatory without itself being signed by means of the cryptographic key of the second signatory.

5. A method according to claim 1, wherein the delegation data further include data describing a validity period of the delegation token.

6. A method according to claim 1, wherein the delegation data further include description data of delegated powers conferred by the token.

7. A method according to claim 1, wherein the delegation token further comprises timestamp information for the token.

8. A method according to claim 1, wherein a revocation server is provided for storing information on possible revocation of the delegation token by the first signatory.

9. A method according to claim 8, wherein the delegation data further include an access address to the revocation server.

10. A method according to claim 1, wherein the delegation data are signed electronically by means of a cryptographic key of the first signatory.

11. A method according to claim 1, wherein the delegation data further include an identifier of the first signatory and are signed electronically by means of a cryptographic key of a third party.

12. A method according to claim 1, wherein the delegation token is associated by the second signatory with the document signed electronically by means of a cryptographic key of the second signatory.

13. A method according to claim 1, wherein the delegation token is sent to the second signatory by the server.

14. A method according to claim 13, wherein the delegation token is associated with the signed document by an applet downloaded from the server to a station of the secondary signatory.

15. A method according to claim 1, wherein the second signatory signs the document electronically and submits the signed document to the server, and wherein the server associates the signed document with the delegation token.

16. A method according to claim 1, wherein said request is accompanied by data depending on the document to be signed which are included in said delegation data to generate the delegation token.

17. A method according to claim 16, wherein said data depending on the document to be signed comprise a code obtained by hashing the document.

18. A computer device for electronic signature of documents by a second signatory delegated by a first signatory, comprising means for electronically signing a document by means of a cryptographic key of the second signatory, means for obtaining a token of delegation from the first signatory to the second signatory, and means for associating the delegation token with the signed document, wherein the delegation token comprises delegation data electronically signed for the first signatory, wherein the delegation data include an identifier of the second signatory, and wherein the means for obtaining the delegation token are adapted to send a request relating to the signing of the document to a server and to receive the token in response to said request.

19. A device according to claim 18, wherein the signature means are adapted to sign electronically the document accompanied by the delegation token, by means of the cryptographic key of the second signatory.

20. A device according to claim 18, wherein the signature means are adapted to sign electronically on the one hand the document and on the other hand authenticated attributes including the delegation token, by means of the cryptographic key of the second signatory.

21. A device according to claim 18, wherein the delegation data further include data describing a validity period of the delegation token.

22. A device according to claim 18, wherein the delegation data further include data describing delegated powers conferred by the token.

23. A device according to claim 18, wherein the delegation data further include an access address to a revocation server storing information on possible revocation of the delegation token by the first signatory.

24. A device according to claim 18, wherein the delegation token further comprises timestamp information for the token.

25. A device according to claim 18, wherein said request is accompanied by data depending on the document to be signed.

26. A delegation server for use in the electronic signing of documents by a second signatory delegated by a first signatory, comprising means for generating a token of delegation from the first signatory to the second signatory in response to a request sent by the second signatory in connection with the signing of a document, wherein the delegation token contains delegation data electronically signed for the first signatory, and wherein the delegation data include an identifier of the second signatory.

27. A server according to claim 26, further comprising means for sending the delegation token to the second signatory for association with the document signed electronically by means of a cryptographic key of the second signatory.

28. A server according to claim 27, further comprising means for uploading an applet to a station of the secondary signatory in order to control the association of the delegation token with the electronically signed document.

29. A server according to claim 26, wherein said request is accompanied by data depending on the document to be signed which are included in said delegation data to generate the delegation token.

30. A server according to claim 26, wherein said data depending on the document to be signed comprise a code obtained by hashing the document.

31. A server according to claim 26, further comprising means for receiving the signed document from the second signatory, and means for associating the signed document with the delegation token.

32. A server according to claim 26, wherein the delegation data further include data describing a validity period of the delegation token.

33. A server according to claim 26, wherein the delegation data further include description data of delegated powers conferred by the token.

34. A server according to claim 26, wherein the delegation token further comprises timestamp information for the token.

35. A server according to claim 26, wherein the delegation data further include an access address to a revocation server provided for storing information on possible revocation of the delegation token by the first signatory.

36. A server according to claim 26, wherein the delegation data further include an identifier of the first signatory and are signed electronically by means of a cryptographic key of a third party.

37. A computer program product to be installed in a computer device for electronic signature of documents by a second signatory delegated by a first signatory, comprising instructions for carrying out the following steps when the program is run by processing means of said device:
sending a request to a delegation server in connection with the signing of a document;
receiving a token of delegation from a first signatory to a second signatory, generated by the server in response to said request, wherein the delegation token contains delegation data electronically signed for the first signatory, wherein the delegation data include an identifier of the second signatory;
electronically signing the document by means of a cryptographic key of the second signatory; and
associating the delegation token with the signed document.

38. A computer program product according to claim 37, wherein the electronic signature performed by means of the cryptographic key of the second signatory is applied to the document accompanied by the delegation token.

39. A computer program product according to claim 37, wherein the electronic signature performed by means of the cryptographic key of the second signatory is applied on the one hand to the document and on the other hand to authenticated attributes including the delegation token.

40. A computer program product according to claim 37, wherein the delegation token is associated with the document signed by means of the cryptographic key of the second signatory without itself being signed by means of the cryptographic key of the second signatory.

41. A computer program product according to claim 37, including an applet downloaded from the server to said computer device.

42. A computer program product according to claim 37, wherein said request is accompanied by data depending on the document to be signed which are included in said delegation data to generate the delegation token.

43. A computer program product according to claim 42, wherein said data depending on the document to be signed comprise a code obtained by hashing the document.

44. A computer program product to be installed in a delegation server involved in the electronic signature of documents by a second signatory delegated by a first signatory, comprising instructions for carrying out the following steps when the program is run by processing means of said server:
receiving a request from the second signatory in connection with the signing of a document; and
generating a token of delegation from a first signatory to a second signatory in response to said request, to be associated with the document signed electronically by means of a cryptographic key of the second signatory,
wherein the delegation token contains delegation data electronically signed for the first signatory, wherein the delegation data include an identifier of the second signatory.

45. A computer program product according to claim 44, further instructions means for sending the delegation token to the second signatory for association with the document signed electronically by means of the cryptographic key of the second signatory.

46. A computer program product according to claim 45, further comprising instructions for uploading an applet to a station of the secondary signatory in order to control the association of the delegation token with the electronically signed document.

47. A computer program product according to claim 44, wherein said request is accompanied by data depending on the document to be signed which are included in said delegation data to generate the delegation token.

48. A computer program product according to claim 44, wherein said data depending on the document to be signed comprise a code obtained by hashing the document.

49. A computer program product according to claim 44, further comprising instructions for receiving the signed document from the second signatory, and instructions for associating the signed document with the delegation token.

50. A computer program product according to claim 44, wherein the delegation data further include data describing a validity period of the delegation token.

51. A computer program product according to claim 44, wherein the delegation data further include description data of delegated powers conferred by the token.

52. A computer program product according to claim 44, wherein the delegation token further comprises timestamp information for the token.

53. A computer program product according to claim 44, wherein the delegation data further include an access address to a revocation server provided for storing information on possible revocation of the delegation token by the first signatory.

54. A computer program product according to claim 44, wherein the delegation data further include an identifier of the first signatory and are signed electronically by means of a cryptographic key of a third party.
